(19) United States
(12) Patent Application Publication
(10) Pub. No.: US 2009/0139130 A1
(43) Pub. Date: Jun. 4, 2009

(54) Tip-Up Notification System for Ice Fishing

(76) Inventor: Mario Nozzarella, Coon Rapids, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 12/326,095

(22) Filed: Dec. 1, 2008

Related U.S. Application Data
(60) Provisional application No. 60/991,703, filed on Nov. 30, 2007.
(60) Provisional application No. 60/991,722, filed on Dec. 1, 2007.

(51) Int. Cl. A01K 97/01; G08B 21/00

(52) U.S. Cl. 43/17; 340/665

(57) ABSTRACT

The present invention is a notification system used to notify a fisherman when a fish has taken the bait at a particular ice fishing hole. The notification system includes a receiver/transmitter system used in conjunction with a tip-up device associated with a fishing line. When the tip-up is activated due to the application of pressure to a fishing line, a transmitter sends a signal to a receiver. The receiver includes a signaling means, which notifies a user when a signal has been received from the transmitter. One receiver may be used with a plurality of tip-ups and transmitters. The receiver may be adapted to distinguish between the signals transmitted by different transmitters. The receiver may also include signaling means which provide information regarding which transmitter sent a signal, so a user may determine which tip-up has been activated in situations where several transmitters are associated with one receiver.

### RELATED APPLICATIONS

The application claims priority under 35 U.S.C. §119(e) from U.S. Provisional Patent Application No. 60/991,703, filed on Nov. 30, 2007, and from U.S. Provisional Patent Application No. 60/991,722, filed on Dec. 1, 2007, the contents of which applications are incorporated herein by reference.

### TECHNICAL FIELD

This invention relates to a notification system used to notify a fisherman when a fish has taken the bait at a particular ice fishing hole. More specifically, the invention relates to a receiver/transmitter system used in conjunction with a tip-up device associated with a fishing line. This receiver/transmitter system notifies a fisherman when a fish has struck the bait attached to the fishing line.

### BACKGROUND

A tip-up is a device used by ice fishermen to indicate that a fish has taken the bait at a particular ice fishing hole. The tip-up has a spring-loaded flag that is released by a trip mechanism. The trip mechanism is activated when pressure is applied to the fishing line, such as when a fish strikes the bait on the hook attached to the fishing line. An embodiment of a tip-up device is described by U.S. Pat. No. 4,021,958, which is incorporated by reference herein.

Sometimes the tip-up is located out of sight from the fishermen, or it is located at such a distance from the fishermen that they are unable to clearly see the tip-up flag. In such situations, the fishermen are not able to see the flag when it is released due to the activation of the trip mechanism. Consequently, the fishermen do not know when the fish has taken the bait associated with the tip-up. Therefore, there is a need for a remote notification system used in conjunction with a tip-up so that fishermen may be notified that a fish has taken the bait, in situations where the fishermen are not able to clearly see the tip-up flag.

### SUMMARY OF INVENTION

The present invention is directed to a notification system used to notify a fisherman when a fish has taken the bait at a particular ice fishing hole. The notification system includes a receiver/transmitter system used in conjunction with a tip-up device associated with a fishing line.

In one embodiment of the present invention, the notification system comprises a tip-up which includes a fishing line, wherein the tip-up is adapted to be activated when pressure is applied to the fishing line. Specifically, the tip-up is adapted such that when a fish strikes the bait attached to the hook of the fishing line, thereby pulling on the fishing line, a trip mechanism of the tip-up is activated, or tripped. The tip-up is designed such that when the trip mechanism is activated, a magnet included in the tip-up device moves closer to a transmitter which includes a reed switch. When the magnet moves closer to the transmitter due to the activation of the trip mechanism, the reed switch is activated, thereby causing the transmitter to send a signal to a receiver. The receiver includes a signaling means, which notifies the fishermen using the system when a signal has been received from the transmitter. This signaling means may signal the fishermen using, for example, lights or sound.

In some embodiments of the present invention, the receiver is portable, so that fishermen may carry a receiver with them. Therefore, if they are too far away from the tip-up to be able to see that it has been activated due to a fish strike, the fishermen may be alerted of the fish strike by the receiver that they are carrying. The receiver may also be kept in a shelter where it can be seen by fishermen. For example, the receiver could be hung on the wall of a fish house.

One receiver may be used with a plurality of tip-ups and transmitters. The receiver may be adapted to distinguish between the signals transmitted by different transmitters. The receiver may also include signaling means which can provide information regarding which transmitter sent a signal, so that fishermen are able to determine which tip-up has been activated in situations where several transmitters are associated with one receiver.

### BRIEF DESCRIPTION OF THE DRAWINGS

For the purposes of facilitating the understanding of the subject matter sought to be protected, there is illustrated in the accompanying drawings an embodiment thereof. From an inspection of the drawings, when considered in connection with the following description, the subject matter sought to be protected, its construction and operation, and many of its advantages should be readily understood and appreciated.

FIG. 1 is a perspective view of an embodiment of a tip-up in accordance with the present invention, with the flag lowered.

FIG. 2 is a diagrammatic side view of an embodiment of a tip-up notification system in accordance with the present invention, with the flag lowered.

FIG. 3 is a diagrammatic side view of the tip-up notification system of FIG. 2, with the flag raised.

### DETAILED DESCRIPTION

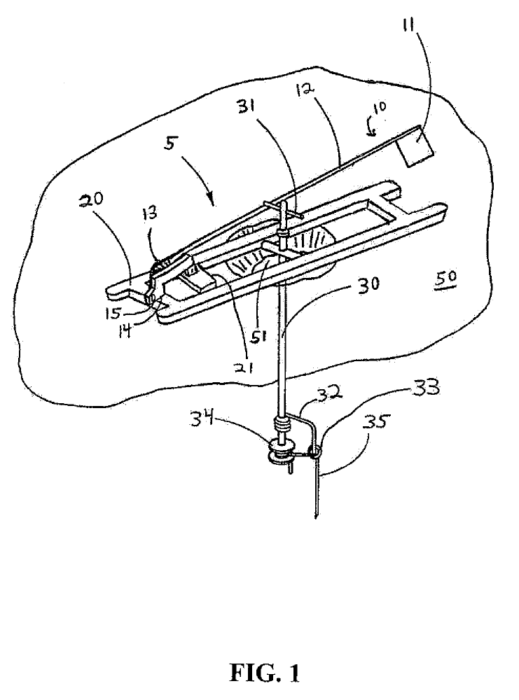

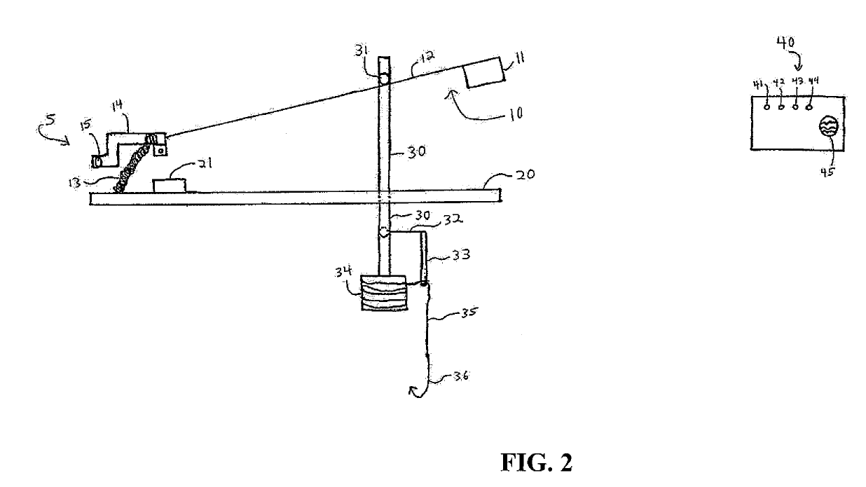

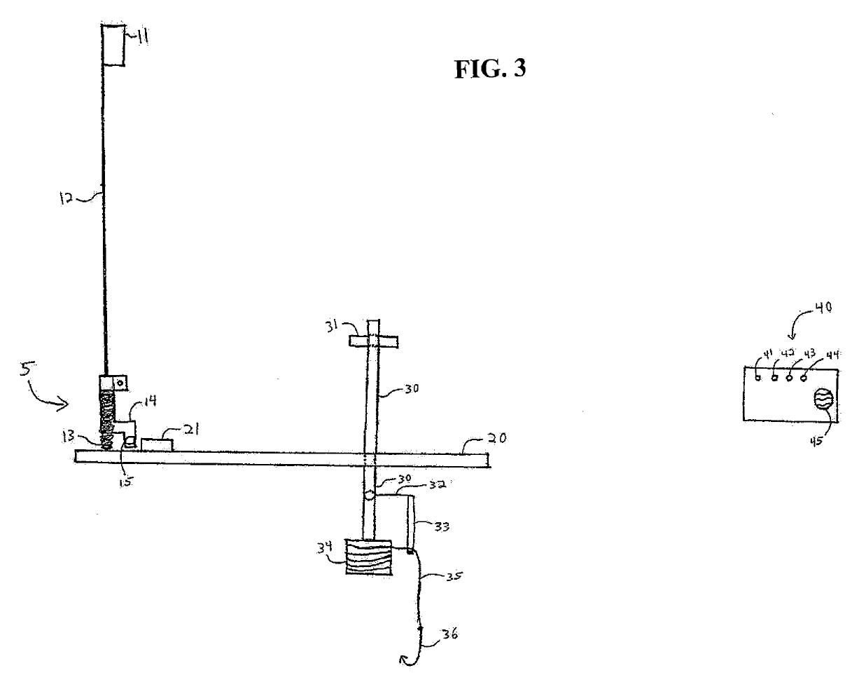

The present invention is directed to a tip-up notification system for ice fishing. One embodiment of a tip-up, which forms part of the tip-up notification system, is shown in FIG. 1. One embodiment of the tip-up notification system is shown in FIGS. 2 and 3. FIGS. 1 and 2 show a tip-up before a fish has struck the hook; therefore, the flag 11 of the tip-up 5 is lowered. FIG. 3 shows the embodiment of FIG. 2 after a fish has struck the hook; therefore, the flag 11 of the tip-up 5 has been raised. As shown in FIG. 1, a flag assembly 10 includes a flag 11 attached to a staff 12. The staff, or flag staff, 12 is attached to a spring 13. A support 14 for a magnet 15 is attached to the staff 12. A magnet 15 is attached to support 14.

The spring 13 is secured to a base 20. The spring 13 may be a flexible coil spring.

A transmitter 21 is located on base 20 between the spring 13 and a shaft 30. The transmitter 21 includes a reed switch. The transmitter may be connected to or include a power source, such as a battery.

The shaft 30 is secured to the base 20 in a manner that allows the shaft to rotate, but at the same time prevents the shaft from dropping through the base 20. The shaft 30 may pass through a hole in the base 20. Both the hole of the base 20 and the shaft 30 may be threaded so that the shaft 30, while capable of rotating, does not drop through the base. A peg 31 is affixed to the shaft 30, above the base 20. Below the base 20, a spool 34 of fishing line 35 is secured to the base of the shaft 30. A support 32 is attached to the shaft 30 between the base 20 and the spool 34. The support 32 extends outwardly from the shaft 30. The support 32 includes an eye 33. The line 35 passes through this eye 33, and a hook 36 is secured to the end of the line 35, as shown in FIGS. 2 and 3. Bait is placed on the hook 36.

A receiver 40, which is depicted in FIGS. 2 and 3, is located at a location remote from the base 20 and transmitter 21. The receiver may be connected to or include a power source such as a battery. The receiver may include a plurality of visual indicators, such as lights. The receiver 40 of FIG. 2 includes four lights 41, 42, 43, and 44. The transmitter may also include a device which can generate and/or emit sound, such as a speaker or a bell. The receiver 40 of FIG. 2 includes a speaker 45. The receiver may be portable, so that fishermen may carry the receiver with them. The receiver may also be hung on the wall of a shelter, such as a fish house.

As shown in FIG. 1, when in use during ice fishing, the base 20 rests over a hole 51 in the ice 50. One end of the base 20 rests on the ice 50 on one side of the hole 51 in the ice, while the other end of the base 20 rests on the ice 50 on the opposite side of the hole 51. The spool 34 and fishing line 35 are located in the water under the ice.

FIGS. 1 and 2 show the tip-up 5 when the flag 11 is lowered. The flag is lowered by bending, or flexing, the spring 13 so that the staff 12 is below the peg 31 of the shaft 30. The staff 12 is placed directly underneath the peg 31, so that it rests against the peg 31. The peg 31 prevents the staff 12 from moving upward. When the spring is flexed as shown in FIG. 2, the magnet 15 on support 14 is located away from the transmitter 21. The spring 13, when flexed as shown in FIG. 2, is located between the magnet 15 and the transmitter 21.

When a fish strikes the bait on the hook 36, fishing line 35 is pulled from the spool 34. The force of the fish pulling on the line 35 causes the spool 34 to rotate. The rotation of the spool 34 causes the shaft 30 to rotate. The spool 34 may be secured to the shaft 30 such that they rotate together, or the spool 34 may be secured to the shaft in such a manner that the spool is able to rotate on the shaft 30. If the spool 34 rotates on the shaft 30, the friction between the spool and the shaft which is generated by the spool's rotation causes the shaft to rotate. When the shaft 30 rotates, the position of the peg 31 in relation to the staff 12 is changed. Specifically, when the flag is lowered as shown in FIGS. 1 and 2, the peg 31 is generally perpendicular to the staff 12, and to the length of the base 20. However, when the line 35 is pulled, causing the shaft 30 to rotate, the peg 31, which is secured to the shaft in such a way that it does not move independently from the shaft, is moved such that it is no longer perpendicular to the length of the base 20. For example, the shaft 30 may be rotated such that, as shown in FIG. 3, the peg is parallel to length of the base. Therefore, when the shaft 30 rotates, the peg 31 is no longer positioned such that the staff 12 is held underneath the peg 31. When the staff 12 is no longer held in place by the peg 31, the spring 13 is no longer held in a flexed position. The force from the spring 13 moving from a flexed position to an erect position causes the staff 12 to be raised to a position perpendicular to the base 20, as shown in FIG. 3. Hence, the flag 11 is raised.

Other types of tip-up mechanisms than the one described above may be used in accordance with the present invention.

If the flag is visible to the fishermen, the fishermen will know, when the flag is raised, that the bait on the hook has been struck. However, the flag may be out of sight of the fishermen, or the fishermen may be unable to see the flag clearly. Fishermen who cannot see the flag may be notified that the bait has been struck due to the transmitter/receiver system of the present invention.

When the flag 11 is raised from its position in FIGS. 1 and 2 to its position in FIG. 3, the magnet 15 on the support 14 is moved closer to the transmitter 21. As shown in FIG. 3, the magnet 15 is near the transmitter 21 when the flag 11 is raised, and the spring 13 is no longer positioned between the magnet 15 and the transmitter 21. The transmitter 21 includes a reed switch, which is activated (either by opening or closing the contacts) when the reed switch is in close proximity to the magnet 15. When the flag is lowered, as shown in FIGS. 1 and 2, the magnet 15 is too far from the transmitter 21 to activate the reed switch. However, when the flag is raised, as shown in FIG. 3, the magnet 15 is close enough to the transmitter 21 to activate the reed switch. When the reed switch is activated, the transmitter 21 transmits a signal to the receiver 40. Other types of switches besides a reed switch may be used in accordance with the present invention. Moreover, types of switches that are activated in a different manner than by proximity to a magnet may be used in accordance with the present invention. For example, a switch activated by the pressure exerted by the flag while it is being raised may be used.

The transmission of the signal from the transmitter to the receiver may be wireless. The signal may be transmitted via, for example, radio frequency, infrared light, or by other means of transmitting signals wirelessly.

When the receiver 40, as depicted in FIGS. 2 and 3, receives a signal from the transmitter 21, the receiver provides a signal to the fishermen that the tip-up has been activated. Receivers may include one or more of a variety of different signaling devices, such as lights or speakers, that provide a signal when a tip-up is activated. For example, the signal provided by the receiver may be one or more of lights 41, 42, 43, and 44 lighting up. The signal provided by the receiver may also be noise emanating from the speaker 45. A screen, such as the screen of a computer monitor, may also function as a signaling device of a receiver. The screen may provide information via, for example, words, lights, or symbols, when a tip-up is activated. If a screen is used as a signaling device, the tip-up notification system may include computer software which regulates the information appearing on the screen.

A plurality of different tip-ups and transmitters can be used in conjunction with one receiver. For instance, in FIGS. 2 and 3, a receiver with four lights is used. Each of these four lights may be associated with a different transmitter. For example, one transmitter could cause light 41 to light up; a second transmitter could cause light 42 to light up; etc. Therefore, the receiver shown in FIGS. 2 and 3 may be used in conjunction with four different tip-ups and transmitters.

The receiver may also emit a sound whenever a transmitter associated with the receiver transmits a signal. A user, alerted by the sound emitted by the receiver, could then look at the receiver to see which light was on. By determining which light was on, the user would know which transmitter had sent a signal, and, therefore, which tip-up had been activated by a fish strike.

The transmitter may include a “randomize” button. When the “randomize” button is pushed, the transmitter creates a unique code by random number generation, so that each transmitter can be considered unique, even when different transmitters are used with the same receiver.

In addition, the receiver may have the ability to “learn” the transmitter codes that are to be associated with the receiver's group of transmitters. This is accomplished by pressing a “learn” button in the receiver. In one embodiment, after the “learn” button is pressed, the plurality of tip-ups (such as four tip-ups) associated with the receiver must be activated within the next 20 seconds. The tip-ups must be activated so that the receiver can learn the unique code of each of the transmitters. If the time expires before all of the tip-ups have been activated, a user may press the “learn” button again and activate the remaining tip-ups.

In some embodiments of the invention, the receiver may be carried by a user. In other embodiments, the receiver may remain in a shelter where fishermen would see the receiver, such as in a fish house.

The transmitter 21 and receiver 40 of the present invention may be used in conjunction with an existing tip-up, if the tip-up is modified to include a magnet that moves closer to the transmitter 21 when the staff of the tip-up transitions from a lowered position to a raised position. The transmitter 21 and receiver 40 of the present invention may also be used in conjunction with an existing tip-up if the tip-up is adapted such that a switch is activated when the staff transitions from a lowered position to a raised position.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A notification system for ice fishing comprising:
a transmitter comprising a reed switch;
a tip-up having a base, a flag staff connected to the base, a shaft which passes through the base, and a spool of fishing line connected to the shaft in such a manner that rotation of the spool causes the shaft to rotate, wherein the tip-up is adapted such that the rotation of the shaft is capable of activating a trip mechanism causing the flag staff to transition from a lowered position to a raised position, and wherein a support including a magnet is connected to the flag staff such that the magnet is brought into closer proximity to the transmitter when the flag staff transitions from the lowered position to the raised position;
and a receiver adapted to receive signals from the transmitter;
wherein the system is adapted such that when the magnet of the tip-up is brought into closer proximity to the transmitter as a result of the transition of the flag staff from the lowered position to the raised position, the reed switch of the transmitter is activated, thereby causing the transmitter to send a signal to the receiver.

2. The notification system of claim 1, further comprising a spring having a first end and a second end, wherein the first end is attached to the base of the tip-up.

3. The notification system of claim 2, wherein the support including the magnet is connected to the second end of the spring.

4. The notification system of claim 1, wherein the receiver comprises a signaling device.

5. The notification system of claim 4, wherein the signaling device comprises a speaker.

6. The notification system of claim 4, wherein the signaling device comprises a visual indicator.

7. The notification system of claim 1, wherein the system comprises a plurality of transmitters and a plurality of tip-ups, and wherein each transmitter is associated with one tip-up.

8. The notification system of claim 7, wherein the receiver comprises a signaling device.

9. The notification system of claim 8, wherein the signaling device comprises a speaker.

10. The notification system of claim 8, wherein the signaling device comprises a visual indicator.

11. The notification system of claim 10, wherein the visual indicator is a light.

12. The notification system of claim 8, wherein the signaling device comprises a plurality of visual indicators.

13. The notification system of claim 12, wherein each visual indicator of the signaling device is associated with one transmitter.

14. The notification system of claim 7, wherein each transmitter is adapted to send a unique signal to the receiver, such that the receiver is able to distinguish between signals sent by different transmitters.

15. A notification system for ice fishing comprising:
a first tip-up having a first fishing line, wherein said first tip-up is adapted to be activated when pressure is applied to the first fishing line;
a second tip-up having a second fishing line, wherein said second tip-up is adapted to be activated when pressure is applied to the second fishing line;
a first transmitter adapted to send a first signal when the first tip-up is activated;
a second transmitter adapted to send a second signal when the second tip-up is activated;
and a receiver adapted to receive the first signal and the second signal, said receiver including a signaling device, wherein the signaling device includes a first visual indicator and a second visual indicator, wherein the first visual indicator is adapted to be activated by the first signal, and wherein the second visual indicator is adapted to be activated by the second signal.

16. The notification system of claim 15, wherein the first transmitter has a first transmitter code and the second transmitter has a second transmitter code.

17. The notification system of claim 16, wherein the first transmitter code is created by random number generation.

18. The notification system of claim 17, wherein the second transmitter code is created by random number generation.

19. A notification system for ice fishing comprising:
a first tip-up having a first fishing line, wherein said first tip-up is adapted to be activated when pressure is applied to the first fishing line;
a second tip-up having a second fishing line, wherein said second tip-up is adapted to be activated when pressure is applied to the second fishing line;
a first transmitter adapted to send a first signal when the first tip-up is activated;
a second transmitter adapted to send a second signal when the second tip-up is activated;
and a receiver including a computer screen, wherein the receiver is adapted to receive the first signal and the second signal.

20. The notification system of claim 19, wherein the computer screen is adapted to function as a signaling device.
